(19) United States
(12) Patent Application Publication
(10) Pub. No.: US 2026/0160100 A1
(43) Pub. Date: Jun. 11, 2026

(54) LOAD RECEIVER, DOOR SUPPORT APPARATUS, AND REFRIGERATION APPARATUS

(71) Applicant: PHC Holdings Corporation, Tokyo (JP)

(72) Inventor: Kousei MATSUDA, Saitama (JP)

(21) Appl. No.: 19/179,784

(22) Filed: Apr. 15, 2025

Related U.S. Application Data
(63) Continuation of application No. PCT/JP2023/037896, filed on Oct. 19, 2023.

(30) Foreign Application Priority Data
Nov. 28, 2022 (JP) 2022-189094

(51) Int. Cl. E05D 3/02; E05D 9/00; F25D 23/02

(52) U.S. Cl. CPC E05D 3/02; E05D 9/00; F25D 23/028; F25D 2323/024

(57) ABSTRACT

A load receiver that is used together with a hinge that supports a door in a turnable state with respect to a door supporting member, the load receiver including: a first member that is fixed to the door supporting member and includes a load receiving surface facing upward; and a second member that is fixed to the door and includes a received surface facing downward, wherein the load receiving surface and the received surface make sliding contact with each other in an opposing state in an up-down direction on a turning central axis of the hinge in a usage state.

### CROSS-REFERENCE OF RELATED APPLICATIONS

This application is a Continuation of International Patent Application No. PCT/JP2023/037896, filed on Oct. 19, 2023, which in turn claims the benefit of Japanese Patent Application No. 2022-189094, filed on Nov. 28, 2022, the entire disclosure of which Applications are incorporated by reference herein.

### TECHNICAL FIELD

The present invention relates to a load receiver, a door support apparatus, and a refrigeration apparatus.

### BACKGROUND ART

In the related art, as disclosed in PTL 1, a refrigeration apparatus including a box including a storage chamber is known. Such a refrigeration apparatus includes an openable door that closes the opening of the box.

### CITATION LIST

### Patent Literature

PTL 1

Japanese Patent Application Laid-Open No. 2019-7668

### SUMMARY OF INVENTION

### Technical Problem

Incidentally, in the above-described refrigeration apparatus, the door is supported by the box through a hinge. This hinge turnably supports the door with respect to the box while receiving the load of the door. As the weight of the door increases, the load received by the hinge increases, which may increase the wear at the hinge.

In view of this, an object of the present invention is to provide a load receiver, a door support apparatus, and a refrigeration apparatus that can reduce the load of the door exerted on the hinge.

### Solution to Problem

A load receiver according to the present invention is used together with a hinge that supports a door in a turnable state with respect to a door supporting member, the load receiver including: a first member that is fixed to the door supporting member and includes a load receiving surface facing upward; and a second member that is fixed to the door and includes a received surface facing downward, wherein the load receiving surface and the received surface make sliding contact with each other in an opposing state in an up-down direction on a turning central axis of the hinge in a usage state.

A door support apparatus according to the present invention includes: a support hinge that supports door in a turnable state with respect to the door supporting member; and the above-described load receiver.

A refrigeration apparatus according to the present invention includes: the above-described door support apparatus; a box that is the door supporting member; the door; at least a pair of the hinges that supports the door in a turnable state with respect to the box; and the load receiver that is disposed between the pair of hinges in the up-down direction.

### Advantageous Effects of Invention

According to the present invention, a load receiver, a door support apparatus, and a refrigeration apparatus that can reduce the load of the door exerted on the hinge can be provided.

### BRIEF DESCRIPTION OF DRAWINGS

FIG. 1 is a perspective view of a refrigeration apparatus according to an embodiment of the present invention;

FIG. 2A is a perspective view illustrating an example of a fixation side hinge member of a hinge;

FIG. 2B is a perspective view as viewed from arrow A₁₁ of FIG. 2A;

FIG. 2C is a perspective view as viewed from arrow A₁₂ of FIG. 2A;

FIG. 2D is a perspective view as viewed from arrow A₁₃ of FIG. 2A;

FIG. 3A a perspective view illustrating an example of a door side hinge member of the hinge;

FIG. 3B is a perspective view as viewed from arrow A₂₁ of FIG. 3A;

FIG. 3C is a perspective view as viewed from arrow A₂₂ of FIG. 3A;

FIG. 3D is a perspective view as viewed from arrow A₂₃ of FIG. 3A;

FIG. 4 is a diagram for describing a general configuration of the hinge;

FIG. 5A is a front view illustrating an example of a box side member of a load receiver;

FIG. 5B is a perspective view as viewed from arrow A₃₁ of FIG. 5A;

FIG. 5C is a perspective view as viewed from arrow A₃₂ of FIG. 5A;

FIG. 6A is a front view illustrating an example of a door side member of the load receiver;

FIG. 6B is a perspective view as viewed from arrow A₄₁ of FIG. 6A;

FIG. 6C is a perspective view as viewed from arrow A₄₂ of FIG. 6A;

FIG. 7 is a diagram for describing a general configuration of the load receiver; and

FIG. 8 illustrates a positional relationship between the hinge and the load receiver.

### DESCRIPTION OF EMBODIMENTS

In the following, with reference to the drawings, a load receiver, a door support apparatus, and a refrigeration apparatus according to the present invention are described. Note that, the same components are denoted with the same reference numerals. The matters described below with reference to the attached drawings are intended to explain exemplary embodiments and are not intended to represent the sole embodiment.

### Embodiment

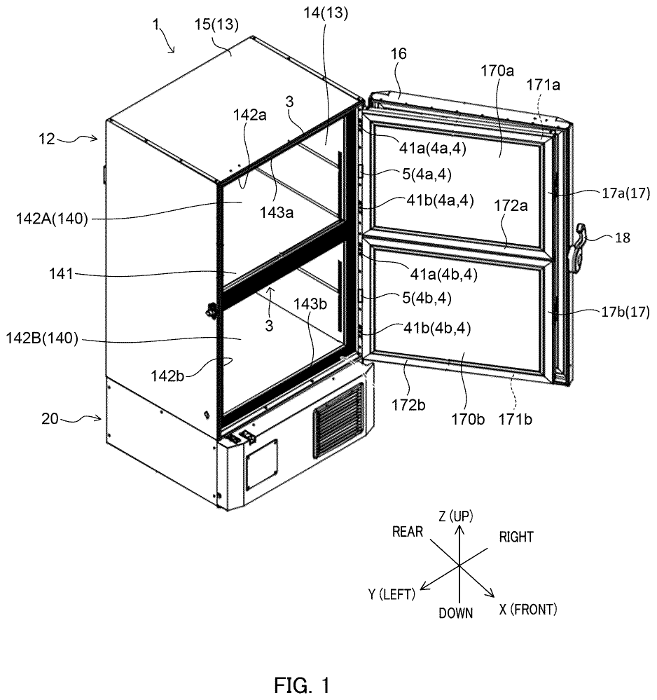

With reference to FIGS. 1 to 8, a load receiver, a door support apparatus, and a refrigeration apparatus according to the embodiment of the present invention are described below.

FIG. 1 is a perspective view of refrigeration apparatus 1 according to the embodiment of the present invention. Refrigeration apparatus 1 is, for example, an ultra-low-temperature freezer. An ultra-low-temperature freezer refers to a device that cools the interior to an ultra-low temperature (e.g., approximately −80° C.). Note that, refrigeration apparatus 1 may also be a medical refrigerator, a blood storage refrigerator, or an incubator.

Note that, in the following description, the orthogonal coordinate system (X, Y, Z) illustrated in FIG. 1 may be used for describing structures of refrigeration apparatus 1 and each component of refrigeration apparatus 1. The X direction corresponds to the front-rear direction of refrigeration apparatus 1. The +side of the X direction corresponds to the front side of refrigeration apparatus 1. The −side of the X direction corresponds to the rear side of refrigeration apparatus 1.

In addition, the Y direction corresponds to the left-right direction of refrigeration apparatus 1 and the width direction of freezing apparatus 1. The +side of the Y direction corresponds to the left side when freezing apparatus 1 is viewed from the front side of refrigeration apparatus 1. The −side of the Y direction corresponds to the right side when refrigeration apparatus 1 is viewed from the front side of refrigeration apparatus 1. The Z direction corresponds to the up-down direction of refrigeration apparatus 1. The +side of the Z direction corresponds to the upper side of refrigeration apparatus 1. The −side of the Z direction corresponds to the lower side of refrigeration apparatus 1.

In the following, a basic configuration of refrigeration apparatus 1 is briefly described. Refrigeration apparatus 1 according to the present embodiment includes main body 12, and machine part 20.

Main body 12 has a box shape. A heat insulation material (not illustrated in the drawing) is disposed in the wall making up main body 12. Main body 12 includes box 13, outer door 16, inner door 17, and handle 18.

Box 13 corresponds to an example of the door supporting member, and includes inner case 14, and outer case 15.

Inner case 14 corresponds to an example of the door supporting member, and is composed of a metal plate and/or a synthetic resin plate, for example. Inner case 14 is composed of a box-shaped member with the front surface open.

Inner case 14 includes storage chamber 140. Storage chamber 140 is partitioned by partition plate 141 into a plurality of (in the present embodiment, two) divided storage chambers 142A and 142B.

In the present embodiment, storage chamber 140 is partitioned by partition plate 141 into divided storage chamber 142A on the upper side and divided storage chamber 142B on the lower side. Each of divided storage chambers 142A and 142B has an opening in the front surface.

Note that, the number of partition plates is not limited to the number of partition plates 141 of the present embodiment. That is, the number of divided storage chambers is not limited to the number of divided storage chambers 142A and 142B of the present embodiment. In addition, the partition plate may be omitted.

Outer case 15, which corresponds to an example of the door supporting member, is composed of a metal plate and/or a synthetic resin plate, for example. Outer case 15 is composed of a box-shaped member with the front surface open. Outer case 15 is composed of a box-shaped member larger than inner case 14. Outer case 15 houses inner case 14.

Outer door 16 is attached to box 13, with outer case 15 in an openable and closable state. In the state where outer door 16 closes the opening of outer case 15 (hereinafter referred to as a closed state of outer door 16), outer case 15 is sealed. A heat insulation material (not illustrated in the drawing) is disposed inside outer door 16. Note that, in the following description, the state where outer door 16 is opened is referred to also as open state of outer door 16.

Inner door 17 is provided on the inside of outer door 16. Note that, unless otherwise noted, the inside means the side closer to inner case 14 and outer case 15 in the closed state of outer door 16 and inner door 17. In addition, unless otherwise noted, the outside means the side remote from inner case 14 and outer case 15 in the closed state of outer door 16 and inner door 17

Inner door 17 is attached to box 13 in the state where openings 142a and 142b of divided storage chambers 142A and 142B of inner case 14 are openable and closeable. Each of openings 142a and 142b corresponds to an example of the opening of the box.

In the present embodiment, inner door 17 includes upper inner door 17a, and lower inner door 17b. Upper inner door 17a is configured to be able to open and close opening 142a of divided storage chamber 142A on the upper side.

Lower inner door 17b is configured to be able to open and close opening 142b of divided storage chamber 142B on the lower side. In the state where upper inner door 17a and lower inner door 17b are closed, the rear side surfaces of upper inner door 17a and lower inner door 17b face divided storage chambers 142A and 142B, respectively.

In the following description, the state where inner door 17 (more specifically, upper inner door 17a and lower inner door 17b) is closed is referred to as the closed state of inner door 17. In addition, the state where inner door 17 (more specifically, upper inner door 17a and lower inner door 17b) is opened is referred to as the open state of inner door 17.

Upper inner door 17a and lower inner door 17b include door side lid parts 170a and 170b that face openings 142a and 142b of divided storage chambers 142A and 142B, respectively, in the closed state. Door side lid parts 170a and 170b have a rectangular shape with substantially the same area as openings 142a and 142b of divided storage chambers 142A and 142B.

In addition, upper inner door 17a and lower inner door 17b include door side frame-shaped regions 171a and 171b around door side lid parts 170a and 170b, respectively. Door side frame-shaped regions 171a and 171b are rectangular frame-shaped regions surrounding door side lid parts 170a and 170b.

Door side frame-shaped regions 171a and 171b are regions that, in the closed state of inner door 17, face inner case side frame-shaped regions 143a and 143b described later in a predetermined direction (in the present embodiment, front-rear direction).

In addition, upper inner door 17a and lower inner door 17b include door side receivers 172a and 172b with a rectangular frame shape extending along door side frame-shaped regions 171a and 171b at door side frame-shaped regions 171a and 171b, respectively. Door side receivers 172a and 172b are referred to also as door side breaker. In the closed state of inner door 17, door side receivers 172a and 172b make contact with packing 3 described later.

Handle 18 is a member that is grabbed by the user to open and close outer door 16.

Machine part 20 is disposed immediately below main body 12. In machine part 20, a compressor (not illustrated in the drawing), a condenser (not illustrated in the drawing) and a decompressor (not illustrated in the drawing) making up a refrigeration circuit (not illustrated in the drawing) that can cool down storage chamber 140 (more specifically, divided storage chambers 142A and 142B) to −80° C. or below are housed.

An evaporator (not illustrated in the drawing) making up the refrigeration circuit is disposed in the side wall of main body 12. By the operation of the refrigeration circuit, the inside of storage chamber 140 (more specifically, divided storage chambers 142A and 142B) is cooled.

In addition, refrigeration apparatus 1 includes packing 3 that is sandwiched between inner door 17 and inner case 14 of box 13.

Packing 3 is provided in a rectangular frame-shaped region (hereinafter referred to also as inner case side frame-shaped regions 143a and 143b) surrounding openings 142a and 142b of divided storage chambers 142A and 142B in inner case 14.

Each of inner case side frame-shaped regions 143a and 143b is composed of an annular (more specifically, rectangular frame-shaped) surface facing forward. The shapes of inner case side frame-shaped regions 143a and 143b need only to be shapes that follow the external shapes of openings 142a and 142b of divided storage chambers 142A and 142B in front view. Note that, the front view refers to viewing refrigeration apparatus 1 from the front side.

Inner case side frame-shaped region 143a is a region surrounding divided storage chamber 142A on the upper side. Inner case side frame-shaped region 143a is composed of the front surface of the upper half portion of inner case 14 and the front surface of partition plate 141. Note that, inner case side frame-shaped region 143a may be composed of a frame shaped member (not illustrated in the drawing) fixed to partition plate 141 and inner case 14.

Inner case side frame-shaped region 143b is a region surrounding divided storage chamber 142B on the lower side. Inner case side frame-shaped region 143b is composed of the front surface of the lower half portion of inner case 14 and the front surface of partition plate 141. Note that, inner case side frame-shaped region 143b may be composed of a frame shaped member (not illustrated in the drawing) fixed to partition plate 141 and inner case 14.

In the present embodiment, each of inner case side frame-shaped regions 143a and 143b is provided with packing 3.

Refrigeration apparatus 1 with the above-described configuration includes door support apparatus 4 that supports inner door 17 (more specifically, upper inner door 17a and lower inner door 17b) in a turnable state at inner case 14.

In the following description, the end portion that supports inner door 17 (more specifically, upper inner door 17a and lower inner door 17b) at inner case 14 is referred to as support side end portion. In addition, the end portion supported by inner case 14 at inner door 17 (more specifically, upper inner door 17a and lower inner door 17b) is referred to as supported end portion.

In the present embodiment, the support side end portion of inner case 14 corresponds to the right end portion of inner case 14. In addition, the supported end portion of inner door 17 (more specifically, upper inner door 17a and lower inner door 17b) corresponds to the end portion of inner door 17 disposed on the right side in the closed state of inner door 17 (more specifically, upper inner door 17a and lower inner door 17b).

Door support apparatus 4 includes upper door support apparatus 4a and lower door support apparatus 4b. Each of upper door support apparatus 4a and lower door support apparatus 4b corresponds to an example of the door support apparatus.

Upper door support apparatus 4a supports upper inner door 17a at inner case 14. Lower door support apparatus 4b supports lower inner door 17b at inner case 14. Upper door support apparatus 4a and lower door support apparatus 4b have the same configuration. A configuration of upper door support apparatus 4a is described below. The description for upper door support apparatus 4a may be read as necessary for the configuration of lower door support apparatus 4b.

Upper door support apparatus 4a includes a plurality of (in the present embodiment, two) hinges 41a and 41b, and load receiver 5.

Upper hinge 41a supports the upper end portion of the supported end portion of upper inner door 17a at the upper end portion of the portion corresponding to upper inner door 17a at the support end portion of inner case 14. Lower hinge 41b supports the lower end portion of the supported end portion of upper inner door 17a at the lower end portion of the portion corresponding to upper inner door 17a at the support end portion of inner case 14.

A configuration of hinge 41a is described below. The configuration of hinge 41b is the same as the configuration of hinge 41a. The description for hinge 41a may be read as necessary for the configuration of hinge 41b.

Hinge 41a includes fixation side hinge member 411, door side hinge member 412, and shaft member 413.

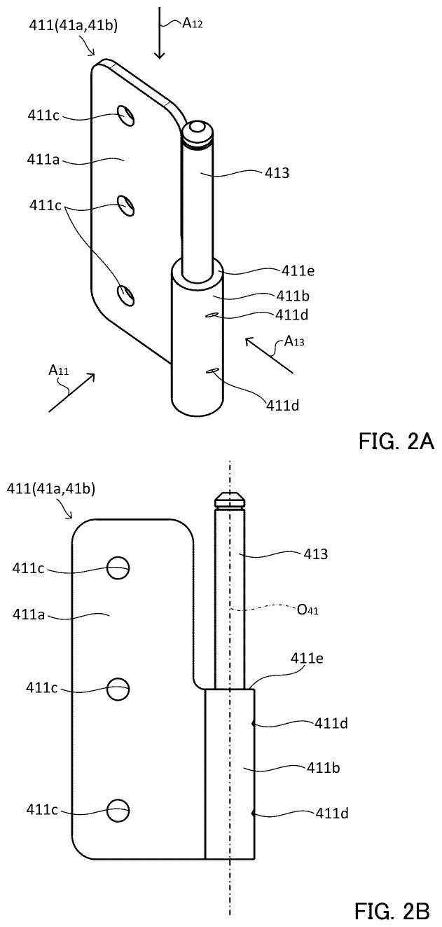

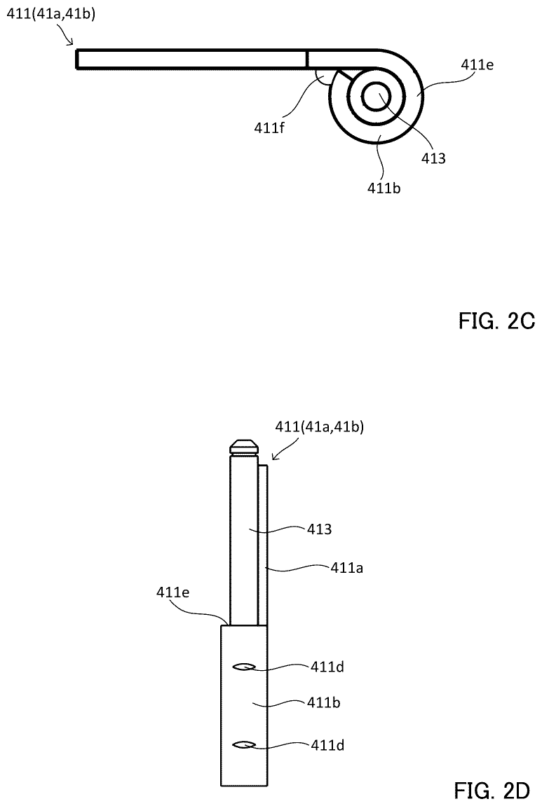

As illustrated in FIGS. 2A to 2D, fixation side hinge member 411 corresponds to an example of the fixation side hinge member, and includes fixation side plate 411a and fixation side sleeve 411b. Fixation side hinge member 411 also corresponds to an example of the portion fixed to the door supporting member.

Fixation side plate 411a is a rectangular plate-shaped metal member. The material of fixation side plate 411a may be stainless steel such as SUS304, for example. Fixation side plate 411a is a portion fixed to inner case 14. Fixation side plate 411a includes a plurality of through holes 411c formed side by side in the up-down direction.

Fixation side plate 411a is fixed to inner case 14 with a plurality of fastening members such as screws (not illustrated in the drawing) inserted into through hole 411c. More specifically, fixation side plate 411a is fixed to the upper end portion of the support end portion of inner case 14.

Fixation side sleeve 411b is a portion that supports shaft member 413 described later. Fixation side sleeve 411b is a cylindrical member made of metal and extending in the up-down direction. The material of fixation side sleeve 411b may be stainless steel such as SUS304, for example.

Fixation side sleeve 411b is formed integrally with fixation side plate 411a. This fixation side plate 411a is formed by partially bending the metal plate making up fixation side plate 411a. The both end portions of fixation side sleeve 411b in the up-down direction are open.

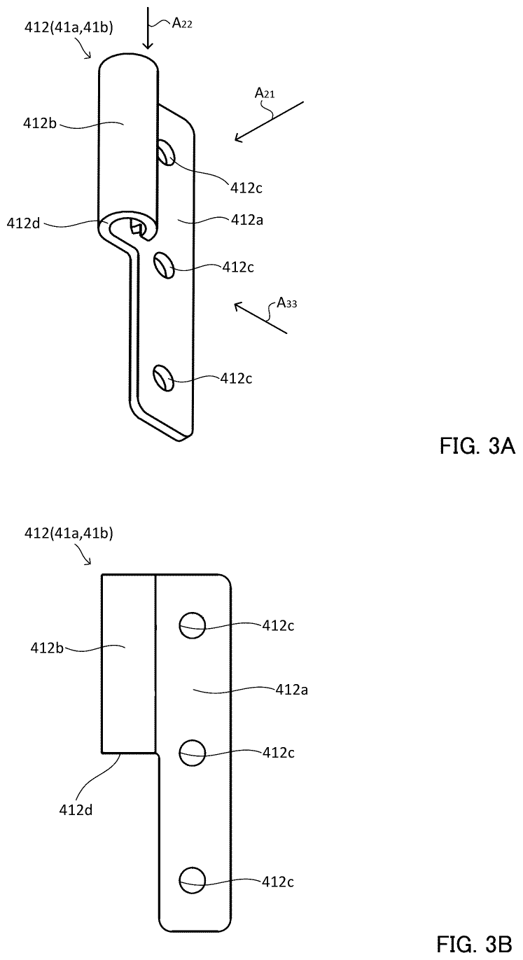

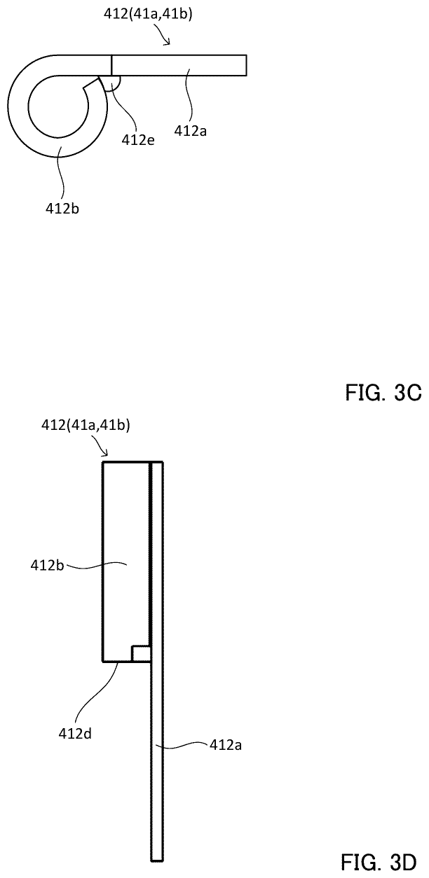

Fixation side sleeve 411b includes ring-shaped load receiving surface 411e at the upper end surface. Load receiving surface 411e makes (sliding) contact with received surface 412d (see FIG. 3A) of door side sleeve 412b of door side hinge member 412 described later in the up-down direction. Load receiving surface 411e is a portion that supports the load of upper inner door 17a on the basis of the (sliding) contact with received surface 412d.

Note that, the end portion of fixation side sleeve 411b in the circumferential direction is joined to fixation side plate 411a by means of welding part 411f (see FIG. 2C).

As illustrated in FIGS. 3A to 3D, door side hinge member 412 corresponds to an example of the door side hinge member, and includes door side plate 412a and door side sleeve 412b. Door side hinge member 412 also corresponds to an example of the portion fixed to the door.

Door side plate 412a is a rectangular plate-shaped metal member. The material of door side plate 412a may be stainless steel such as SUS304, for example. Door side plate 412a is the portion fixed to upper inner door 17a. Door side plate 412a includes a plurality of through holes 412c formed side by side in the up-down direction.

Door side plate 412a is fixed to upper inner door 17a by means of a plurality of fastening members such as screws (not illustrated in the drawing) inserted into through hole 412c. More specifically, door side plate 412a is fixed to the upper end portion of the supported end portion of inner door 17.

Door side sleeve 412b is a portion that supports shaft member 413 described later. Door side sleeve 412b is a cylindrical member made of metal and extending in the up-down direction. The material of door side sleeve 412b may be stainless steel such as SUS304, for example.

Door side sleeve 412b is formed integrally with door side plate 412a. This door side sleeve 412b is formed by partially bending the metal plate making up door side plate 412a. The both end portions of door side sleeve 412b in the up-down direction are open.

Door side sleeve 412b includes, at the lower end surface, ring-shaped received surface 412d. Received surface 412d makes contact with load receiving surface 411e of fixation side sleeve 411b of fixation side hinge member 411 in the up-down direction.

Note that, the end portion of door side sleeve 412b in the circumferential direction is joined to door side plate 412a by means of welding part 412e (see FIG. 3C).

As illustrated in FIGS. 2A and 2B, shaft member 413 is a shaft member made of metal and extending in the up-down direction. The material of shaft member 413 may be stainless steel such as SUS304, for example. The lower half portion of shaft member 413 is inserted into fixation side sleeve 411b.

Shaft member 413 is retained to prevent it from coming out of fixation side sleeve 411b. More specifically, shaft member 413 is retained to fixation side sleeve 411b on the basis of engagement with a plurality of caulking parts 411d formed in fixation side sleeve 411b.

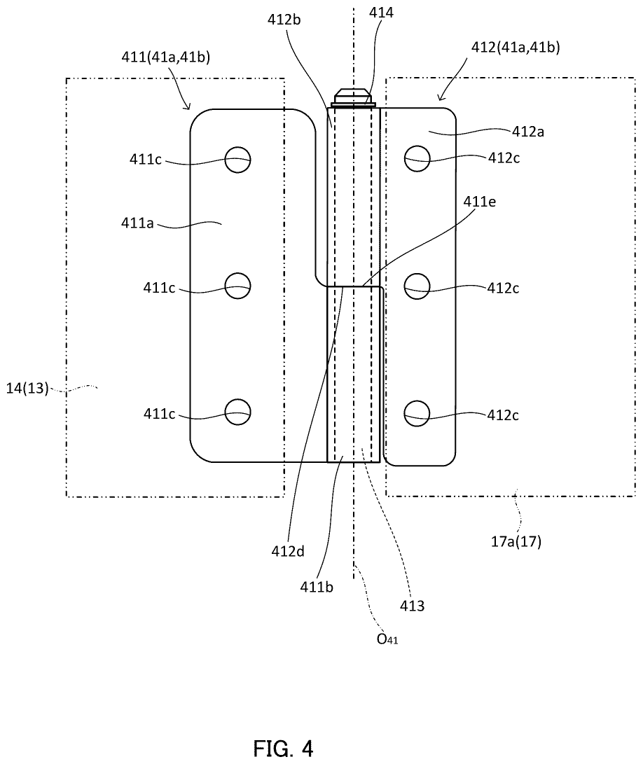

In addition, as illustrated in FIG. 4, the upper half portion of shaft member 413 is inserted from the lower side of door side sleeve 412b of door side hinge member 412. The upper end portion of shaft member 413 protrudes upward from the upper end portion of door side sleeve 412b. E-ring 414 is fixed to the upper end portion of shaft member 413. E-ring 414 prevents shaft member 413 from coming out of door side sleeve 412b of door side hinge member 412.

Shaft member 413 with the above-described configuration is a member making up the turning central axis of hinge 41a. The central axis O₄₁ of shaft member 413 is a straight line parallel to the up-down direction.

Door side hinge member 412 is turnable around shaft member 413 (more specifically, central axis O₄₁) with respect to fixation side hinge member 411.

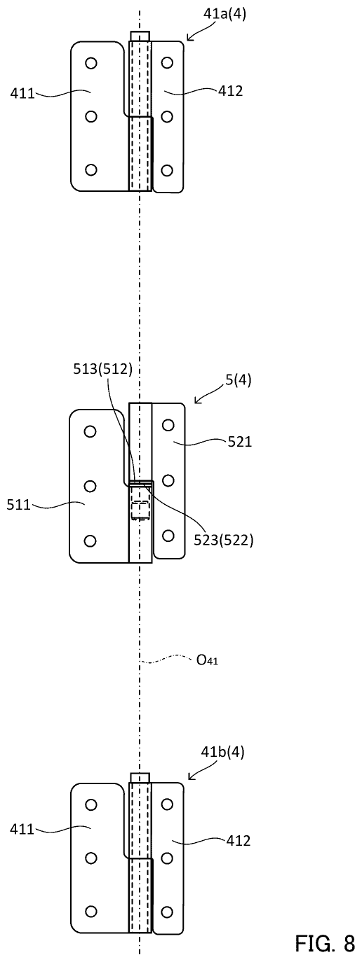

Load receiver 5 is used together with hinges 41a and 41b. Load receiver 5 is provided between (approximately at the center position of) upper hinge 41a and lower hinge 41b in the up-down direction (see FIG. 8).

Load receiver 5 is a member for receiving the load of upper inner door 17a. By receiving a part of the load of upper inner door 17a at load receiver 5, the load of upper inner door 17a exerted on hinges 41a and 41b can be reduced.

More specifically, load receiver 5 includes box side member 51, and door side member 52.

Box side member 51, which includes load receiving surface 513 facing upward, is fixed to inner case 14.

More specifically, box side member 51 corresponds to an example of the first member, and includes box side fixing member 511, and box side receiving member 512.

Box side fixing member 511 corresponds to an example of the first fixed portion, and includes box side plate 511a, and box side sleeve 511b. Box side fixing member 511 is a member with the same structure as that of fixation side hinge member 411 of hinge 41a. That is, box side fixing member 511 and fixation side hinge member 411 are composed of standardized members (components) with the same shape.

Box side plate 511a is a rectangular plate-shaped metal member and corresponds to an example of the first plate. The material of box side plate 511a may be stainless steel such as SUS304, for example.

Box side plate 511a is a portion fixed to inner case 14. Box side plate 511a includes a plurality of through holes 511c formed side by side in the up-down direction.

Box side plate 511a is fixed to inner case 14 with a plurality of fastening members such as screws (not illustrated in the drawing) inserted into through hole 511c. More specifically, box side plate 511a is fixed to a center portion of the portion corresponding to upper inner door 17a at the support end portion of inner case 14 in the up-down direction.

Box side sleeve 511b is a portion that supports box side receiving member 512 described later and corresponds to an example of the first sleeve. Box side sleeve 511b is a cylindrical member made of metal and extending in the up-down direction. The material of box side sleeve 511b may be stainless steel such as SUS304, for example.

Box side sleeve 511b is formed integrally with box side plate 511a. This box side sleeve 511b is formed by partially bending the metal plate making up box side plate 511a. The both end portions of box side sleeve 511b in the up-down direction are open.

Note that, the end portion of box side sleeve 511b in the circumferential direction is joined to box side plate 511a with welding part 511d.

Box side receiving member 512 is a shaft member made of metal and extending in the up-down direction and corresponds to an example of the first receiving member. The material of box side receiving member 512 may be stainless steel such as SUS304, for example. Note that, the material of box side receiving member 512 may be synthetic resins (for example, polyacetal (POM)).

Box side receiving member 512 includes shaft part 512a, and head 512b.

Shaft part 512a is a shaft member, and includes annular recessed groove 512c at an intermediate part in the outer peripheral surface in the axis direction. Recessed groove 512c is continuously provided in the entire outer peripheral surface of shaft part 512a. The outer diameter of shaft part 512a is slightly smaller than the inner diameter of box side sleeve 511b.

Head 512b is provided at one end portion (in the present embodiment, the upper end portion) of shaft part 512a. Head 512b has a disk shape. The outer diameter of head 512b is greater than the outer diameter of shaft part 512a. In addition, the outer diameter of head 512b is greater than the inner diameter of box side sleeve 511b.

The upper end surface of head 512b is a circular flat surface, and makes up load receiving surface 513. Load receiving surface 513 makes sliding contact with received surface 523 in door side member 52 described later. More specifically, load receiving surface 513 and received surface 523 make sliding contact with each other in an opposing state in the up-down direction on the turning central axis O₄₁ of hinges 41a and 41b (see FIG. 8).

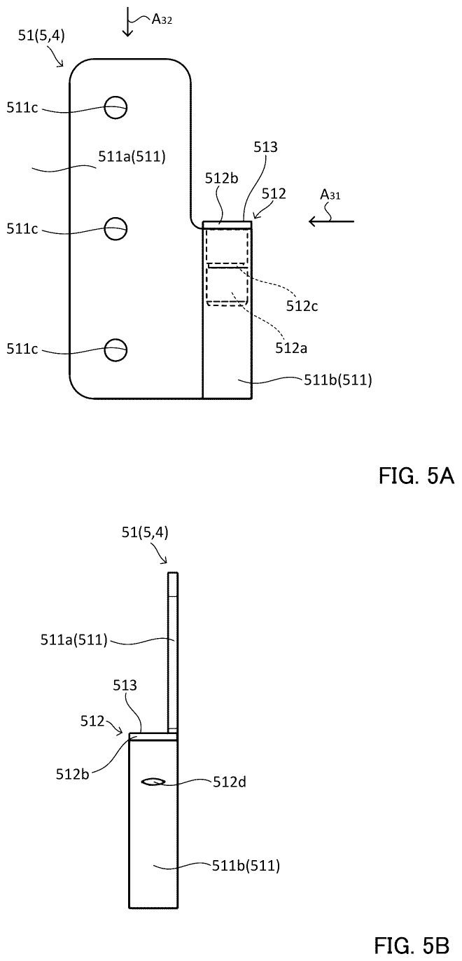

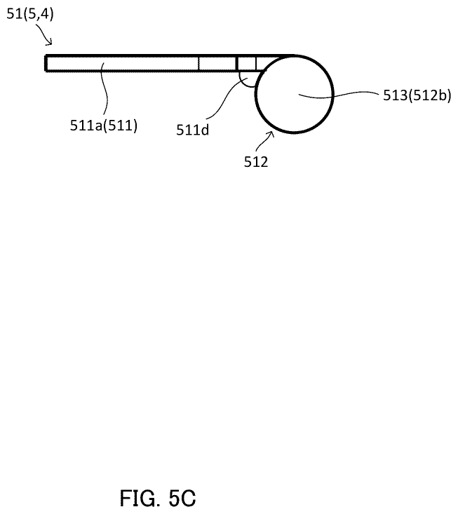

This box side receiving member 512 is fixed to box side sleeve 511b in the state where shaft part 512a is inserted into box side sleeve 511b from the upper side (see FIG. 5A). In this state, head 512b is disposed on the upper end surface of box side sleeve 511b. The bottom surface of head 512b is in contact with the upper end surface of box side sleeve 511b.

In addition, box side receiving member 512 is retained to box side sleeve 511b through engagement of recessed groove 512c and caulking part 512d provided in box side sleeve 511b.

Door side member 52 corresponds to an example of the second member, and includes received surface 523 facing downward. Door side member 52 is fixed to upper inner door 17a.

More specifically, door side member 52 includes door side fixing member 521, and door side receiving member 522.

Door side fixing member 521 corresponds to an example of the second fixed portion, and includes door side plate 521a, and door side sleeve 521b. Door side fixing member 521 also corresponds to an example of the portion fixed to the door.

Door side fixing member 521 is a member with the same structure as that of door side hinge member 412 of hinge 41a. That is, door side fixing member 521 and door side hinge member 412 are composed of standardized members (components) with the same shape.

Door side plate 521a is a rectangular plate-shaped metal member and corresponds to an example of the second plate. The material of door side plate 521a may be stainless steel such as SUS304, for example.

Door side plate 521a is the portion fixed to upper inner door 17a. Door side plate 521a includes a plurality of through holes 521c formed side by side in the up-down direction.

Door side plate 521a is fixed to upper inner door 17a with a plurality of fastening members such as screws (not illustrated in the drawing) inserted into through hole 521c. More specifically, door side plate 521a is fixed to the center portion in the up-down direction at the supported end portion of inner door 17 (more specifically, upper inner door 17a).

Door side sleeve 521b is a portion that supports door side receiving member 522 described later and corresponds to an example of the second sleeve. Door side sleeve 521b is a cylindrical member made of metal and extending in the up-down direction. The material of door side sleeve 521b may be stainless steel such as SUS304, for example.

Door side sleeve 521b is formed integrally with door side plate 521a. This door side sleeve 521b is formed by partially bending the metal plate making up door side plate 521a. Both end portions of door side sleeve 521b in the up-down direction are open.

Note that, the end portion of door side sleeve 521b in the circumferential direction is joined to door side plate 521a with welding part 521e.

Door side receiving member 522 is a shaft member made of synthetic resin and extending in the up-down direction, and corresponds to an example of the second receiving member. The material of door side receiving member 522 may be polyacetal (POM), for example. Note that, the material of door side receiving member 522 may be a metal (for example, stainless steel such as SUS304).

Door side receiving member 522 includes shaft part 522a, and head 522b.

The outer diameter of shaft part 522a is slightly smaller than the inner diameter of door side sleeve 521b.

Head 522b is provided at one end portion (in the present embodiment, the lower end portion) of shaft part 522a. Head 522b has a disk shape. The outer diameter of head 522b is greater than the outer diameter of shaft part 522a. In addition, the outer diameter of head 522b is greater than the inner diameter of door side sleeve 521b.

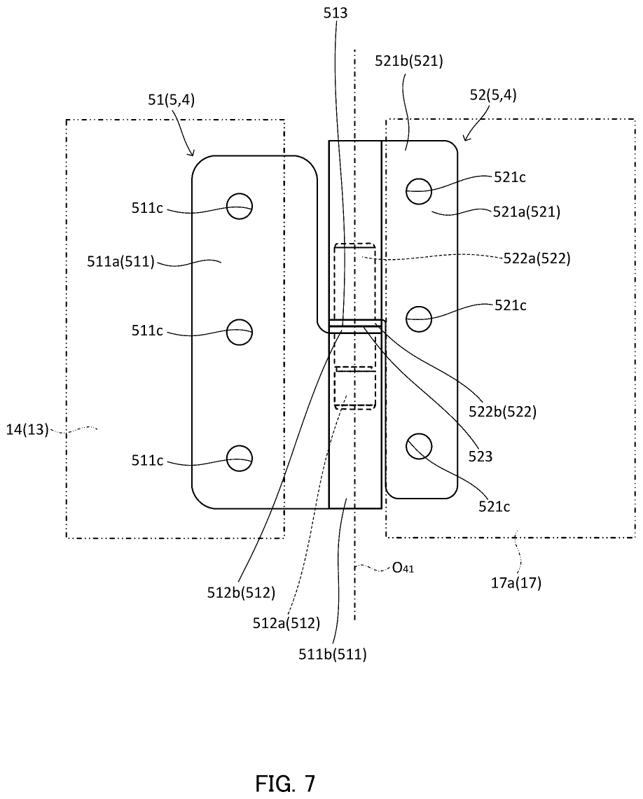

The lower end surface of head 522b is a circular flat surface, and makes up received surface 523. Received surface 523 makes sliding contact with load receiving surface 513 of box side member 51 (see FIGS. 7 and 8).

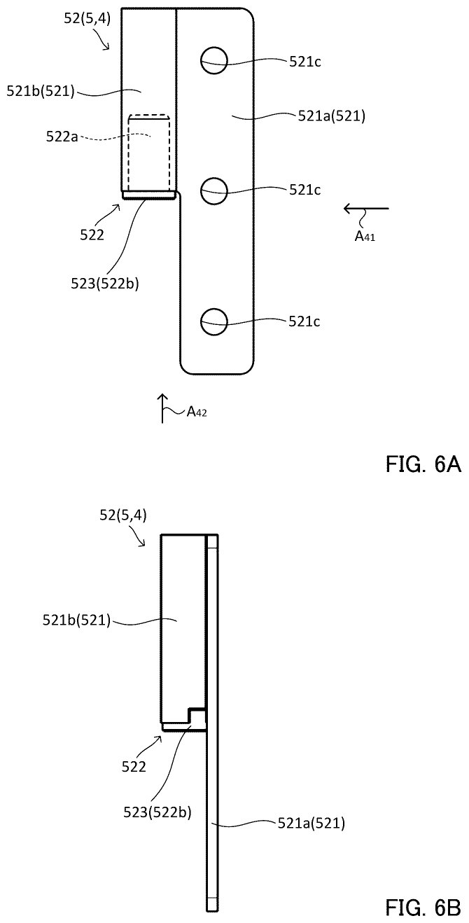

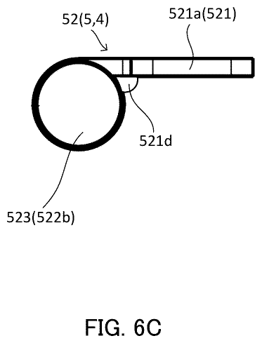

This door side receiving member 522 is fixed to door side sleeve 521b in the state where shaft part 522a is inserted (more specifically, press-fit) into door side sleeve 521b from the lower side (see FIG. 6A).

In this state, head 522b is disposed on the lower side of the lower end surface of door side sleeve 521b. The top surface of head 522b and the lower end surface of door side sleeve 521b are in contact with each other.

Load receiver 5 with the above-described configuration is used in the state illustrated in FIGS. 7 and 8. In the usage state illustrated in FIGS. 7 and 8, load receiving surface 513 of box side member 51 fixed to inner case 14, and received surface 523 of door side member 52 fixed to upper inner door 17a make sliding contact with each other in an opposing state in the up-down direction on the turning central axis O₄₁ of hinge 41a.

Note that, as illustrated in FIG. 7, load receiver 5 does not include a member corresponding to shaft member 413 of hinges 41a and 41b.

In other words, box side member 51 and door side member 52 of load receiver 5 make sliding contact at load receiving surface 513 and received surface 523, but are not coupled with each other. This load receiver 5 can support the load of upper inner door 17a.

It should be noted that, load receiver 5 cannot alone support upper inner door 17a in a turnable state with respect to inner case 14. In view of this, load receiver 5 is different from hinges 41a and 41b.

### Operations and Effects of Present Embodiment

Refrigeration apparatus 1 with the above-described configuration according to the present embodiment includes door support apparatus 4 (more specifically, upper door support apparatus 4a and lower door support apparatus 4b). In addition, door support apparatus 4 (upper door support apparatus 4a and lower door support apparatus 4b) includes hinges 41a and 41b, and load receiver 5.

Hinges 41a and 41b support upper inner door 17a in a turnable state with respect to inner case 14, for example. In addition, hinges 41a and 41b support the load of upper inner door 17a.

In addition, in the present embodiment, load receiver 5 also supports the load of upper inner door 17a. In this manner, the load of upper inner door 17a exerted on hinges 41a and 41b can be reduced. As a result, wear of hinges 41a and 41b can be suppressed.

Note that, in the present embodiment, the load of upper inner door 17a is supported with two hinges 41a and 41b and one load receiver 5. The ratio of the load supported by hinges 41a and 41b and load receiver 5 may be set as necessary.

For example, the ratio of the load supported by load receiver 5 can be adjusted by adjusting the shapes of box side receiving member 512 and door side receiving member 522 of load receiver 5 (for example, the heights of heads 512b and 522b).

In addition, in the present embodiment, hinges 41a and 41b and load receiver 5 include standardized members (components) with the same shape. More specifically, box side fixing member 511 of hinges 41a and 41b and fixation side hinge member 411 of load receiver 5 are standardized.

In addition, door side fixing member 521 of hinges 41a and 41b and door side hinge member 412 of load receiver 5 are standardized. This configuration can reduce the management cost and the manufacturing cost of components.

### Supplementary Notes

The numbers of hinges and load receivers making up the door support apparatus in the implementation of the door support apparatus according to the present invention are not limited to those in the above-described embodiment case.

In addition, the door support apparatus according to the present invention may be applied to a door support apparatus that supports outer door 16 with respect to outer case 15 in the above-described refrigeration apparatus 1.

In addition, naturally, the door support apparatus according to the present invention may be applied to structures other than the structure of the refrigeration apparatus. The door support apparatus according to the present invention is applicable to various door support apparatuses for supporting the door in a turnable state with respect to the door supporting member.

This application is entitled to and claims the benefit of Japanese Patent Application No. 2022-189094 filed on Nov. 28, 2022, the disclosure each of which including the specification, drawings and abstract is incorporated herein by reference in its entirety.

### INDUSTRIAL APPLICABILITY

The present invention is not limited to refrigeration apparatuses, and is applicable to various door support apparatuses for supporting a door in a turnable state with respect to a door supporting member.

### REFERENCE SIGNS LIST

1 Refrigeration apparatus
12 Body
13 Box
14 Inner case
140 Storage chamber
141 Partition plate
142A, 142B Divided storage chamber
142a, 142b Opening
143a, 143b Inner case side frame-shaped region
15 Outer case
16 Outer door
17 Inner door
17a Upper inner door
17b Lower inner door
170a, 170b Door side lid part
171a, 171b Door side frame-shaped region
172a, 172b Door side receiver
18 Handle
20 Machine part
3 Packing
4 Door support apparatus
4a Upper door support apparatus
4b Lower door support apparatus
41a, 41b Hinge
411 Fixation side hinge member
411a Fixation side plate
411b Fixation side sleeve
411c Through hole
411d Caulking part
411e Load receiving surface
411f Welding part
412 Door side hinge member
412a Door side plate
412b Door side sleeve
412c Through hole
412d Received surface
412e Welding part
413 Shaft member
414E Ring
5 Load receiver
51 Box side member
511 Box side fixing member
511a Box side plate
511b Box side sleeve
511c Through hole
511d Welding part
512 Box side receiving member
512a Shaft part
512b Head
512c Recessed groove
512d Caulking part
513 Load receiving surface
52 Door side member
521 Door side fixing member
521a Door side plate
521b Door side sleeve
521c Through hole
521d Welding part
522 Door side receiving member
522a Shaft part
522b Head
523 Received surface

1. A load receiver that is used together with a hinge that supports a door in a turnable state with respect to a door supporting member, the load receiver comprising:
a first member that is fixed to the door supporting member and includes a load receiving surface facing upward; and
a second member that is fixed to the door and includes a received surface facing downward, wherein
the load receiving surface and the received surface make sliding contact with each other in an opposing state in an up-down direction on a turning central axis of the hinge in a usage state.

2. The load receiver according to claim 1,
wherein the first member includes:
a first fixed portion that is fixed to the door supporting member; and
a first receiving member that is fixed to the first fixed portion and includes the load receiving surface at an upper end surface; and
wherein the second member includes:
a second fixed portion fixed to the door; and
a second receiving member that is fixed to the second fixed portion and includes the received surface at a lower end surface.

3. The load receiver according to claim 2,
wherein the first fixed portion includes:
a first plate that is fixed to the door supporting member; and
a cylindrical first sleeve that is provided integrally with the first plate and extends in the up-down direction,
wherein the first receiving member is inserted into the first sleeve in a state where an upper end portion protrudes upward from the first sleeve,
wherein the second fixed portion includes:
a second plate that is fixed to the door; and
a cylindrical second sleeve that is provided integrally with the second plate and extends in the up-down direction, and
wherein the second receiving member is inserted into the second sleeve in a state where a lower end portion protrudes downward from the second sleeve.

4. The load receiver according to claim 2,
wherein the first fixed portion, the first receiving member, and second fixed portion are made of metal, and
wherein the second receiving member is made of resin.

5. A door support apparatus comprising:
a support hinge that supports door in a turnable state with respect to the door supporting member; and
the load receiver according to claim 1.

6. The door support apparatus according to claim 5,
wherein a portion fixed to the door supporting member in the hinge and a portion fixed to the door supporting member in the load receiver include standardized members with the same shape, and
wherein a portion fixed to the door in the hinge and a portion fixed to the door in the load receiver include standardized members with the same shape.

7. The door support apparatus according to claim 6,
wherein the hinge includes:
a fixation side hinge member that makes up the portion fixed to the door supporting member; and
a door side hinge member that makes up the portion fixed to the door; and
a shaft member that turnably supports the door side hinge member with respect to the fixation side hinge member, the shaft member making up a turning central axis of the hinge,
wherein the first member of the load receiver includes:
a first fixed portion that makes up the portion fixed to the door supporting member, and
a first receiving member that is fixed to the first fixed portion and includes the load receiving surface at an upper end surface, and
wherein the second member of the load receiver includes:
a second fixed portion that makes up the portion fixed to the door; and
a second receiving member that is fixed to the second fixed portion and includes the received surface at a lower end surface.

8. A refrigeration apparatus comprising:
the door support apparatus according to claim 5;
a box that is the door supporting member;
the door;
at least a pair of the hinges that supports the door in a turnable state with respect to the box; and
the load receiver that is disposed between the pair of hinges in the up-down direction.
